(19) United States
(12) Patent Application Publication
(10) Pub. No.: US 2003/0018420 A1
(43) Pub. Date: Jan. 23, 2003

(54) Double acting crash sensor

(76) Inventors: Christopher Apanius, S. Euclid, OH (US); Christopher A. Bang, San Diego, CA (US); Michael Nagy, Lawrenceville, GA (US)

Correspondence Address: THOMPSON HINE L.L.P., 2000 COURTHOUSE PLAZA , N.E., 10 WEST SECOND STREET, DAYTON, OH, 45402, US

(21) Appl. No.: 09/884,387

(22) Filed: Jun. 19, 2001

(51) Int. Cl. G06F 7/00

(52) U.S. Cl. 701/45

(57) ABSTRACT

A crash sensor including a frame, a first contact coupled to the frame and a second contact coupled to the frame. The sensor further includes a mass coupled to the frame, the mass being movable relative to the frame between a first position wherein the mass contacts the first contact and not the second contact and a second position wherein the mass contacts the second contact and not the first contact. The mass can be moved from the first position to the second position when the mass experiences a predetermined acceleration force.

The present invention is directed to a crash sensor, and more particularly, to a micromachined double-acting crash sensor.

### BACKGROUND OF THE INVENTION

Crash sensors are used to detect a predetermined acceleration and to send an output signal upon detection of the predetermined acceleration event. However, existing crash sensors can have a relatively slow reaction time and may lack robustness. Accordingly, there is a need for a robust crash sensor having a quick reaction time.

### SUMMARY OF THE INVENTION

The present invention is a robust, quick-reacting sensor for sensing a predetermined acceleration level. In one embodiment the invention is a crash sensor including a frame, a first contact coupled to the frame and a second contact coupled to the frame. The sensor further includes a mass coupled to the frame, the mass being movable relative to the frame between a first position wherein the mass contacts the first contact and not the second contact and a second position wherein the mass contacts the second contact and not the first contact. The mass can be moved from the first position to the second position when the mass experiences a predetermined acceleration force.

Other objects and advantages of the present invention will be apparent from the following description and accompanying drawings.

### BRIEF DESCRIPTION OF THE DRAWINGS

FIG. 1 is a top view of one embodiment of the sensor of the present invention shown in its rest position;

FIG. 2 is a top view of the sensor of FIG. 1 shown in its ready position;

FIG. 3 is a top view of the sensor of FIG. 1 shown in its trigger position;

FIG. 4 is a side cross section taken along line 4-4 of FIG. 1;

FIG. 5 is a side view of the sensor of FIG. 4 mounted into packaging;

FIG. 6 is a top view of another embodiment of the sensor of the present invention shown in its rest position;

FIG. 7 is a detail view of the actuator of the sensor of FIG. 6;

FIGS. 8-10 are a series of views of the actuator of FIG. 7, showing the steps for moving the actuator to its activated position;

FIG. 11 is a top view of the sensor of FIG. 6 shown in its trigger position;

FIG. 12 is an electrical schematic for a sensor system; and

FIGS. 13-22 are a series of side cross sections illustrating a sequence of manufacturing steps that may be used to manufacture a sensor of FIGS. 1-11.

### DETAILED DESCRIPTION

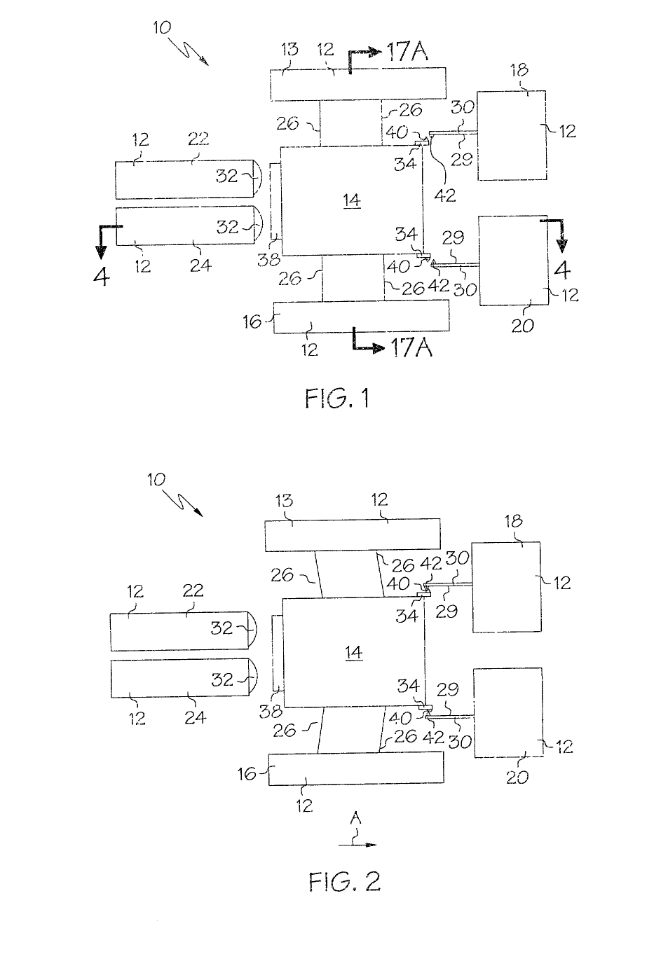

As shown in FIG. 1, the present invention is a crash sensor 10 including a frame 12 and a mass 14 located generally inside the frame 12. In the illustrated embodiment, the frame 12 includes an upper block 13, a lower block 16, a pair of right side blocks 18, 20, and a pair of left side blocks 22, 24. However, the frame 12 may assume a variety of shapes, such as a single body or block that extends around the mass 14. The sensor 10 further includes a set of four flexible arms 26, each arm 26 extending from the frame 12 to the mass 14 to displaceably or movably couple the mass 14 to the frame 12. However, a variety of structures besides the arms 26 may be used to displaceably couple the mass 14 to the frame 12, such as springs, flexible membranes, etc.

The frame 12 includes a pair of normally closed contacts 30 and a pair of normally open contacts 32 located on an opposite side of the frame 12. In the illustrated embodiment, each of the normally closed contacts 30 includes an arm 29 terminating in an inwardly-extending retaining barb 42, and each normally open contact 32 includes a conductive hemispherical surface. The mass 14 includes a pair of electrically coupled normally closed contacts 34 or protrusions 34 (or first internal contacts). Each normally closed contact 34 terminates in an outwardly-extending retaining clip 40 and is preferably located adjacent an associated normally closed contact 30 of the frame 12. The mass 14 further includes a conductive surface 38 (or normally closed contact or second internal contact) located on an opposite side of the mass 14 and adjacent to the normally open contacts 32 of the frame 12. The normally closed contacts 34 of the mass 14 and the normally closed contacts 30 of the frame 12 are shaped as cooperating barbs. The retaining clips 40 and retaining barbs 42 are shaped to lockingly cooperate or interlock to maintain the mass in its position in FIG. 2, as will be described below.

The sensor 10 may be shipped to a customer or an end user in its rest position, as illustrated in FIG. 1. In order to prepare the sensor 10 for operation, the mass 14 is moved from the rest position of FIG. 1 to its ready position of FIG. 2. As noted above, when the sensor 10 is in its ready position, the retaining clips 40 of the mass 14 cooperate with the retaining barbs 42 of the frame 12 to maintain the mass 14 in its ready position. The mass 14 can be moved to its ready position by a variety of means or methods, such as by a mechanical means, including an arm, lever or other instrument, or by acceleration forces (such as by spinning the sensor 10 in a centrifuge), or by an electrostatic comb drive actuator, thermal actuator, or other means.

When the sensor is in its ready position as shown in FIG. 2, the normally closed contacts 30 of the frame are electrically coupled by the mass 14. For example, the mass 14 may include a conductor (not shown) extending between the contacts 34, or the mass 14 and contacts 34 may be made of conductive material themselves. In this manner, a controller or processor (not shown) can determine that the normally closed contacts 30 are closed and in contact with the mass 14, such as by passing a low level current through the normally closed contacts 30 and the mass 14.

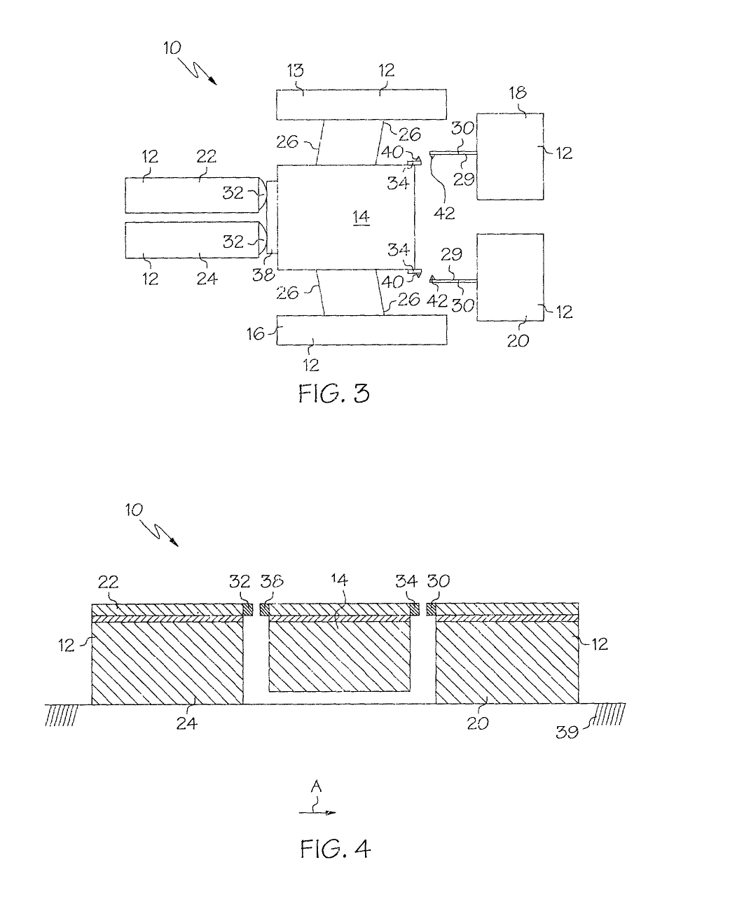

The sensor 10 is then mounted onto a component 39 (or lower wafer 39 which is in turn located on a component) whose acceleration is desired to be sensed (see FIG. 4). Alternately, the sensor 10 may first be mounted onto the component 39 in its rest position, and then shifted to its ready position. After the sensor 10 is moved to its ready position and mounted on the component 39, the sensor 10 is ready to sense a crash or a predetermined acceleration.

When the component 39 (and the sensor 10) experience a predetermined acceleration in the direction indicated by arrow A (or a predetermined deceleration in the direction opposite to A), the interengaging barb/clip portions of the normally closed contacts 30, 34 disengage, and the mass 14 moves to its trigger position as shown in FIG. 3. When the normally closed contacts 34 of the mass 14 break contact with the normally closed contacts 30 of the frame 12, an open circuit is created and detected by the controller. Furthermore, when the mass 14 is located in its trigger position, the conductive surface 38 of the mass 14 engages and electrically couples the normally open contacts 32 of the frame 12, which sends a signal to the controller that the normally open contacts 32 have been closed. For example, a low voltage may be constantly or periodically applied to the normally closed contacts 30 to detect when the circuit is opened. Similarly, a low voltage may be constantly or periodically applied to the open contacts 32 such that the conductive surface 38 completes the circuit when the mass 14 is in its trigger position. In this manner, the sensor 10 can detect that acceleration of a predetermined level has been experienced by the sensor 10.

The normally closed 30, 34 and normally open 32, 38 contacts of the sensor 10 provide a measure of redundancy. For example, when the mass 14 is moved to its trigger position, the normally closed contacts 30 are opened and the normally open contacts 32 are closed, both of which can be sensed by the controller. This provides two signals to the controller that the predetermined acceleration has been sensed.

The mass 14 is typically located in its trigger position in FIG. 3 for only a short period of time. After the acceleration forces are dissipated, the mass 14 will return to its rest position in FIG. 1. After the sensor 10 has returned to its rest position, the sensor 10 can be reset by moving the mass 14 to its ready position and interlocking the retaining clips 40 and retaining barbs 42 to once again enable the sensor 10 to sense a predetermined acceleration.

The sensor 10 may be relatively small, for example, on the order of 3 mm×3 mm or smaller. The small dimensions of the sensor ensure that the mass 14 need only travel a short distance to open the normally closed contacts 30 and close the normally open contacts 32, which enables the sensor 10 to provide a quick response time. The mass 14 is preferably relatively large to provide for a high contact force, break through surface films on the contacts and reduce the influence of stiction. In other words, a relatively high mass/spring constant ratio of the arms is desired. The sensor 10 may also be made from a variety of materials, such as silicon, silicon nitride, polysilicon, glasses, a combination of these materials, or nearly any machinable material.

The sensor 10 may also include one or more actuators (not shown) that provide a self test feature. For example, the sensor 10 may include an actuator that can move the mass 14 between its ready and it trigger position. In this manner, a user can confirm that the controller is properly sensing when the normally closed contacts are opened and/or the normally open contacts are closed.

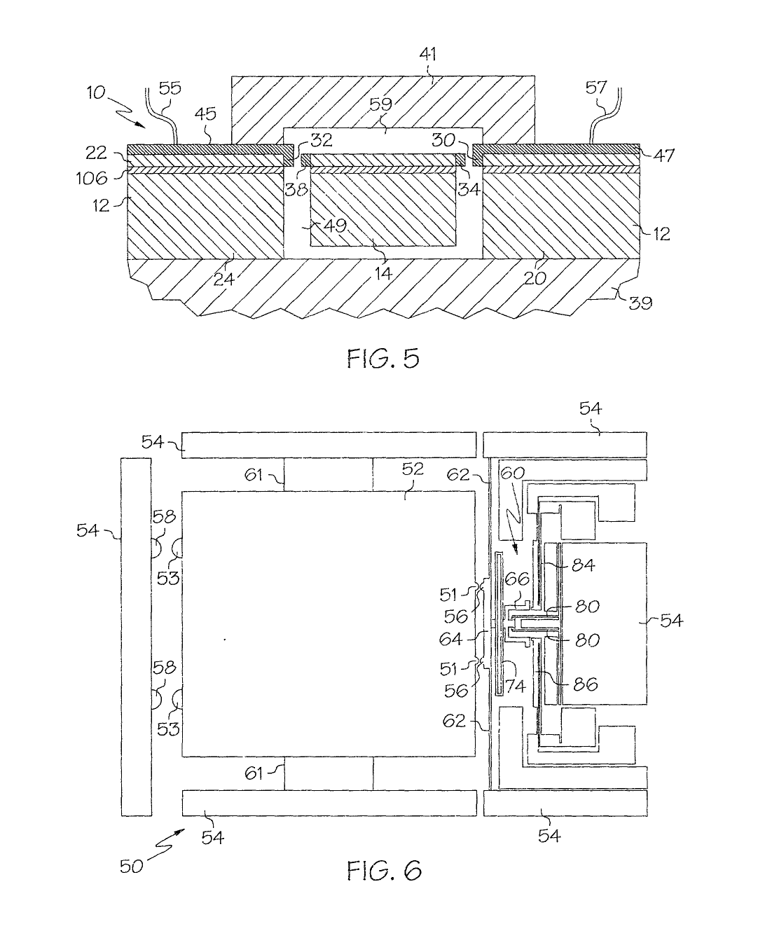

As shown in FIG. 5, the sensor 10 may be packaged by locating a top cap 41 thereon to protect the sensor 10, and a set of contact lines 45, 47 may extend under the top cap 41. A set of wires 55, 57 may be coupled to the contact lines 45, 47 (i.e., via bond pads, not shown) to couple the sensor 10 to an external controller or the like. The top cap 41 can be made from a variety of materials, such as glass or silicon. A stop gap 59 is formed between the top cap 41 and the proof mass 14. The stop gap 59 is preferably relatively small such that the any vertical displacement of the proof mass 14 (i.e. due to vibration, shock forces, etc.) is limited, which helps to improve the life and reliability of the sensor.

The top cap 41 and lower wafer 39 may form a hermetically sealed chamber 49 in which the sensor 10 is received, and the chamber 49 may be filled with a pressurized or partially pressurized fluid that is selected to prevent resonant excitation of the sensor 10. Furthermore, the fluid in the chamber 49 may be selected to tune or adjust the performance of the sensor. For example, a relatively viscous fluid may be used if it is desired to densisitize the sensor 10. Packaging the sensor 10 inside the chamber 49 also helps to seal out any impurities and moisture, such as moisture that may enter the sensor 10 as during a dicing process.

The dimensions of the sensor 10 may vary, although in one embodiment the mass 14 may be about 400 microns wide by 800 microns long by 400-800 microns thick. The contacts 30, 32, 34, 38 may each be a flat plate, or generally hemispherical bumps, or bumps that engage a flat plate, or nearly any other shapes and combination of shapes. When the contacts are flat plates, they may be about 25-100 microns long; when the contacts are hemispherical they may have a radius of between about 10-50 microns. Each arm 26 may have a length of between about 300 to 600 microns, a width of about between about 1 to 4 microns, and a thickness of between about 2 to 40 microns. The high aspect ratio of the arms 26 reduces cross axis sensitivity of the sensor. In other words, the arms may be shaped to reduce movement of the mass 14 in the vertical direction (with reference to FIG. 4). Furthermore, the arms 26 are preferably made of silicon or other material with a relatively high compressive strength to reduce the cross sensitivity of the sensor. Although nearly any number of arms 26 may be used, such as two or more, it has been found that the use of at least four arms helps to reduce twisting/rotation of the proof mass 14.

Although the embodiment shown in FIGS. 1-5 discloses a pair of normally closed contacts 30, 34, a pair of normally open contacts 32 on the frame 12 and a normally open contact 38 on the mass 14, the sensor 11 may include nearly any number of contacts on either the frame 12 or mass 14. Also, the mass 14 and/or frame 12 may include a variety of shapes of contacts for the normally open 32, 38 and normally closed 30, 34 contacts, such as interengaging barb portions, flat contacts, hemispherical, etc or nearly any combination thereof. The shape and material of the mass 14 itself may also act as a “contact.” Furthermore, in one embodiment the frame 12 may include only one normally closed contact 30 and one normally open contact 32 on the frame 12, and the mass 14 may include only one normally closed contact 34, in which case the controller may be able to sense contact between the mass 14 and the contacts by, for example, a change in capacitance when the mass 14 contacts the frame 12. In this case, the mass 14 may have a conductive surface that contacts a single contact on the frame 12, or vice versa.

An alternate embodiment of the sensor of the present invention is illustrated in FIGS. 6-11. As best shown in FIG. 6, the sensor 50 includes a mass 52 having a pair of normally closed, or first internal contacts 51 and a pair of normally open, or second internal contacts 53 located on an opposite side of the mass 52. The sensor 50 includes a frame 54 extending generally around the mass 52, the frame 54 includes a pair of normally closed contacts 56, a pair of normally open contacts 58 and an actuator 60. The mass 52 is coupled to the frame 54 by a coupling structure, such as a set of arms 61, or other structure as described earlier.

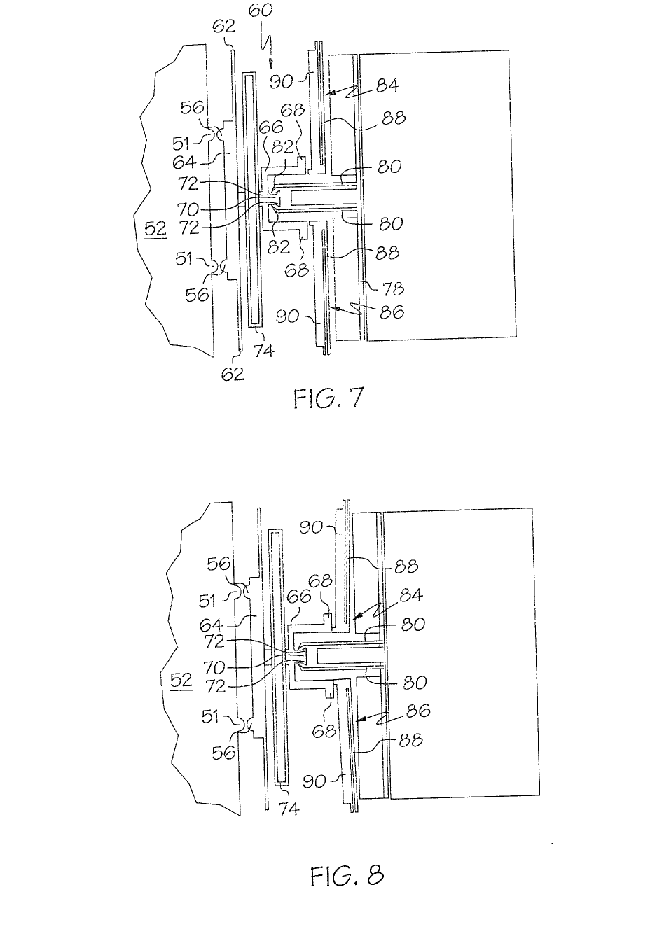

The sensor 50 includes an actuator 60 is coupled to the frame 54 by a pair of connecting arms 62, and includes a central bar 64 that includes the pair of normally closed contacts 56 of the frame 54 thereon. As shown in FIG. 7, the actuator 60 includes an end cap 66 having a pair of opposed outwardly-extending feet 68. The actuator 60 further includes a center stem 70 located inside said end cap 66, the stem 70 having a pair of outwardly extending barb portions 72 on its tip. The actuator 60 further includes a coupling spring 74 located between the end cap 66 and the central bar 64. Various springs, spring-like elements and other biasing mechanisms may be used in place of the coupling spring 74.

The frame 54 includes a frame base 78 and a pair of barb arms 80 that extend outwardly from the frame base 78 and capture the end portion of the center stem 70 therebetween. Each barb arm 80 includes an inwardly-extending tip 82. The actuator 60 further includes a pair of actuator beams 84, 86 that extend generally parallel to the central bar 64. Each actuator beam 84, 86 includes a narrow beam portion 88 and a thick beam portion 90. When the actuator 60 or sensor 50 is in its neutral position, as shown in FIGS. 6-7, the center stem 70 is received within the barb arms 80, and there is a gap between the normally closed contacts 51, 56 and between the normally open contacts 53, 58.

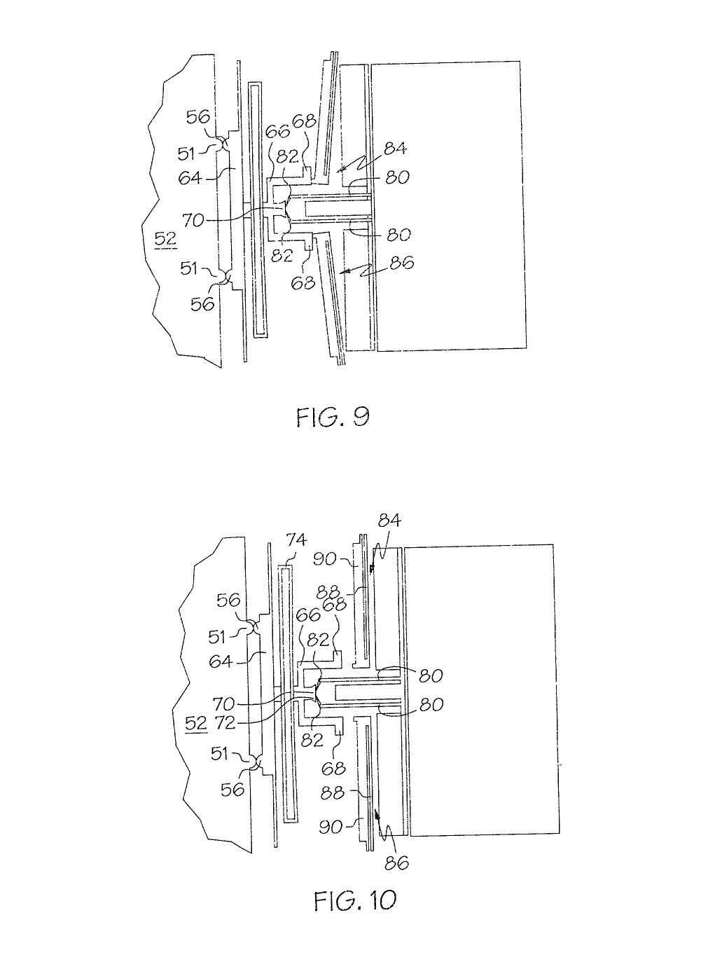

The actuator 60 is used to “preload” the sensor 50 into its ready position. In order to preload the sensor 50, a current may be passed, in series, through the narrow 88 and thick 90 beam portions of each actuator beam 84, 86. As the current is passed through the beam portions 88, 90, the beam portions 88, 90 are heated and thermally expand. Due to the unequal thickness of the beam portions 88, 90, each portion 88, 90 of the actuator beams 84, 86 will thermally expand at different rates, which causes the actuator beams 84, 86 to bend towards the end cap 66, as shown in FIG. 8. The bending motion of the beams 84, 86 is similar to that of a bi-metal thermometer. Upon sufficient displacement of the actuator beams 84, 86, each actuator beam 84, 86 engages a foot 68 of the end cap 66 and pushes the end cap 66 to the left in FIG. 8. As the actuator beams 84, 86 are moved to their actuating position as shown in FIG. 9, they push the center stem 70 out from between the barb arms 80.

As the center stem 70 is moved to the left in FIG. 8, the coupling spring 74 is compressed between the center stem 70 and the center bar 74. As shown in FIG. 9, the normally closed contacts 56 on the central bar 64 are also thereby urged into contact with the normally closed contacts 51 of the mass 52. Once the center stem 70 is pushed out of the barb arms 80, the current passed through the actuator beams 84, 86 can then be terminated. The beams 84, 86 then cool and return to their original position as shown in FIG. 10. However, the contacts 56, center bar 64, coupling spring 74, end cap 66 and center stem 70 remain in their position illustrated in FIG. 9, due to the cooperation between the barbed arms 80 and the barbed portions 72 of the center stem 70 which prevent the center stem 70 from re-entering the recess between the barbed arms 80. Thus, FIG. 10 illustrates the sensor 50 in its ready position, wherein the actuator 60 and mass 52 are both in their ready positions, and the normally closed contacts 56 of the frame 54 are biased into contact with the normally closed contacts 51 of the mass 52.

In this manner, the sensor 50 can be moved to its ready position simply by passing a current through the actuator beams 84, 86. Additionally, instead of having differing thicknesses, the beam portions 88, 90 of the beams 84, 86 may have differing coefficients of thermal expansion which causes them to bend or be displaced upon passing a current through the beams 84, 86. The actuator beams 84, 86 may also be moved to their actuating position by the direct application of heat or by various mechanical means. Furthermore, various other mechanisms of shifting the sensor 50 to its ready position may be used, for example, mechanical means, acceleration forces, electrostatic comb drive actuator, etc., may be used to move the center stem out from between the barbed arms 80 in which case the actuator 60 may not be needed. Additionally, instead of moving the normally closed contacts 56 of the frame, the mass or the contacts of the mass may instead be moved against the frame or contacts of the frame. Furthermore, various other structures for biasing the normally closed contacts 56 of the frame against the normally closed contacts 51 of the mass may be used without departing from the scope of the present invention.

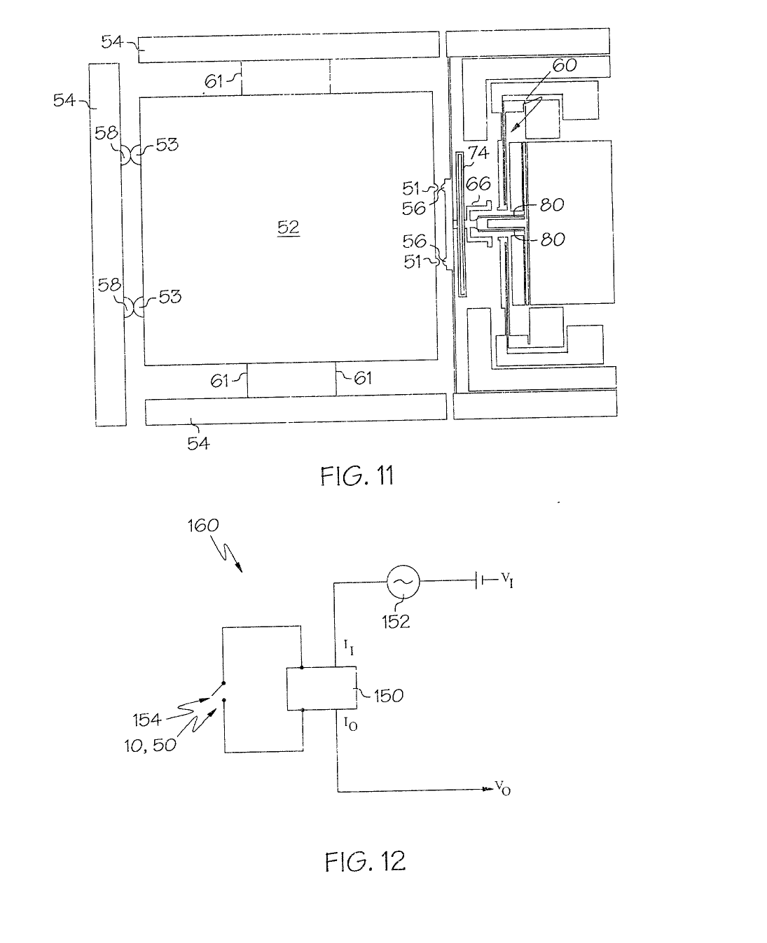

Once the sensor 50 is in its ready position as shown in FIG. 10, it is “preloaded” because the normally closed contacts 56 of the frame 54 are spring biased into engagement with the normally closed contacts 51 of the mass 52, while the normally open contacts 53, 58 remain spaced apart. Upon experiencing a predetermined acceleration, the mass 52 shifts to its trigger position, as shown in FIG. 11, thereby opening the normally closed contacts 51, 56 and closing the normally open contacts 53, 58. As with the embodiment discussed earlier, a controller can sense the opening of the normally closed contacts 51, 56 and the closing of the normally open 53, 58 contacts to determine that an acceleration event has occurred.

Once the mass 52 has been moved to its trigger position and the acceleration forces are dissipated, the mass 52 and the sensor 50 each return to their ready position in FIG. 10, as moved by the arms 61. Because the sensor 50 is “preloaded” and the spring 74 biases the normally closed contacts 56 of the frame 54 against the mass, the mass 52 and sensor 50 automatically return to their ready positions after experiencing an acceleration. In other words, once the sensor 50 of this embodiment is activated, the sensor 50 does not need to be reset to its ready position after the mass 52 is moved to its trigger position. Furthermore, if the sensor 50 is dropped or otherwise jostled such that the mass 52 is moved, the sensor 50 automatically returns to its ready position and does not need to be reset.

The sensor 50 may include an actuator that enables a user to self-test the sensor 50. For example an actuator (not shown) that is similar in function to the actuator 60 may be used to move the sensor from its ready position to its trigger position to ensure that the controller can sense that the normally closed contacts are opened and/or that the normally closed contacts are closed. In the embodiment of FIGS. 6-11, the self test actuator only needs to move the mass 52 to its trigger position. The self test actuator need not move the mass 52 to its ready position, because the mass 52 will automatically return to its ready position so long as the sensor 50 is preloaded (i.e. the actuator 60 is in its ready position). The sensor 50 may be packaged between a top cap 41 and wafer 39, and generally appears in cross section as the sensor as shown in FIG. 5.

This configuration of the sensor 50 enables the sensor to be shipped to an end user in its neutral position shown in FIG. 6. Once the user receives the sensor 50, the user can preload the sensor to its ready position (FIG. 10) by actuating the actuator 60. Once the user “actuates” the sensor, the sensor 50 is ready for use and need not be reset upon each use.

Because the sensors 10, 50 of the present invention can be batch manufactured on a silicon wafer, a set of electronics (not shown) can be incorporated onto the same wafer as the sensors 10, 50. For example, when the sensor 50 is moved to its trigger position (FIG. 11), a drive circuit may be used to detect the closure of the normally open contacts 53, 58 and/or opening of the normally closed contacts 51, 56, and to drive a separate current load to activate a response.

FIG. 12 is an electrical schematic drawing illustrating a drive circuit 160 that may incorporate the sensors 10, 50 of FIGS. 1-11. The normally closed and/or normally open contacts of the sensors 10, 50 form a switch 154 that may be connected to a logic circuit 150. The logic circuit 150 is connected to a current source 152, such as a battery such that the current source 152 supplies an input current I_{I} and the logic circuit 150 has an output current Iₒ. The drive circuit 160 may include an input voltage V_{I} (which may be ground) and an output voltage V_{O} (which may be connected to the output component). In this manner, when the normally open contacts of the sensor 10, 50 are closed, the switch 154 is closed, and the current source 152 can drive the output component. The use of low power electronics, such as the drive circuit, acts as a booster or amplifier and enables the sensor 10, 50 to be used to activate a current larger than a current that can be passed through the sensor 10, 50 itself The drive circuit 160 preferably requires relatively low power and can have a battery life of several years. The use of the drive circuit 160 also improves system reliability by reducing the performance requirements of the mechanical contacts of the sensors 10, 50.

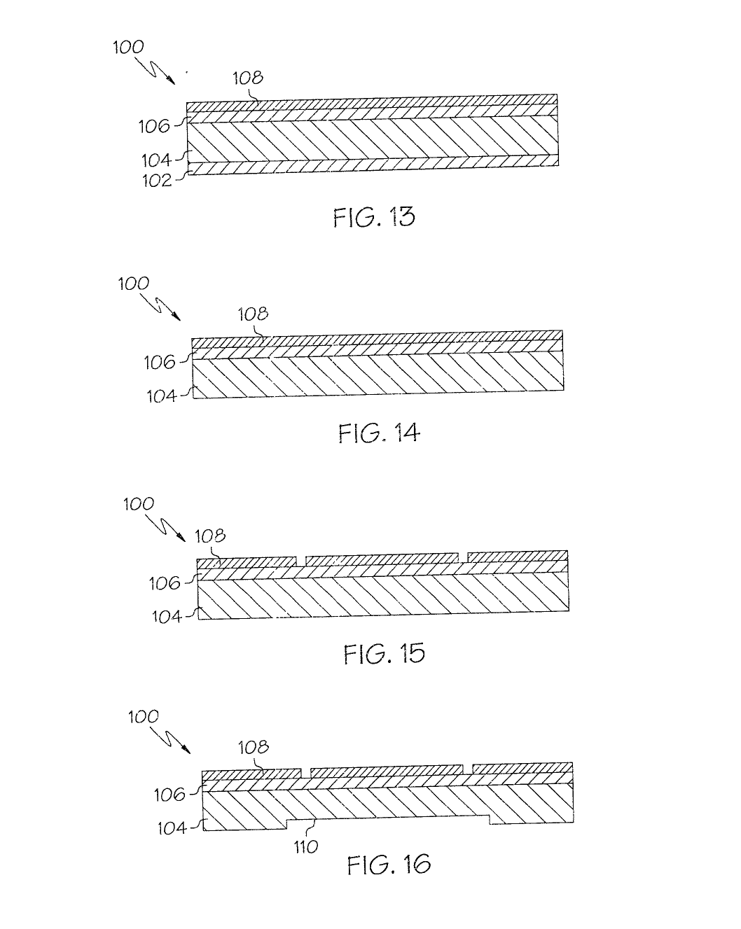

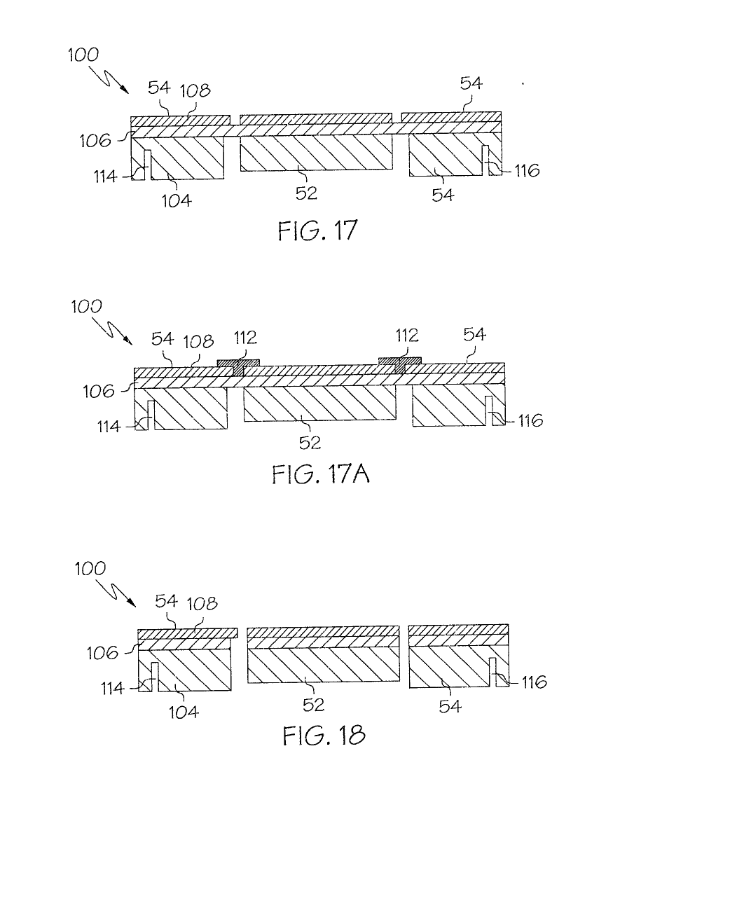

FIGS. 13-22 illustrate one method for forming the sensors 10, 50 of FIGS. 1-11, although various other methods of forming the sensors may be used without departing from the scope of the invention. The sensors may be batch processed such that a plurality of sensors are formed on a single, larger wafer or wafers simultaneously. However, for ease of illustration, FIGS. 13-22 illustrate only a single sensor being formed. The majority of FIGS. 13-22 are longitudinal cross sections that correspond to FIG. 4, and are taken along line 4-4 of FIG. 1. However, FIGS. 17A, 21A and 22A are lateral cross sections taken along line 17A of FIG. 1. Although the reference numbers in FIGS. 13-22 refer to the embodiment of FIGS. 6-11, it should be understood that the process illustrated in FIGS. 13-22 may be used to manufacture a wide variety of sensors, including the sensor illustrate in FIGS. 1-5. Furthermore, the manufacturing steps illustrated herein are only way in which the sensor of the present invention may be manufactured and the order and details of each step described herein may vary, or other steps may be used or substituted.

As shown in FIG. 13, the process begins with a silicon-on-insulator wafer 100 including a bottom layer 102, base layer 104 above the bottom layer 102, an intermediate layer 106 above the base layer 104, and an upper layer 108 of material above the intermediate layer 106. The base layer 104 may be made of silicon having a thickness of about 380 microns but can be made from a variety of materials, including but not limited to polysilicon, amorphous silicon, glass, silicon carbide, germanium, polyimid, ceramics, nitride, or sapphire. The intermediate layer 106 and bottom layer 102 may each be a thermal oxide having a thickness of about 1 micron (note that the thicknesses of the layers in FIGS. 4, 5 and 13-22 are not to scale). However, the particular materials of the bottom layer 102 may not be critical, because the bottom layer may be removed. The intermediate layer 106 may be made from any of a variety of materials beyond a thermal oxide, preferably materials that can act as an etch stop, including but not limited to various glass materials or metals. The upper layer 108 may be silicon having a thickness of about 7.5 microns, but can be made from a variety of materials, including in addition to those listed above for the base layer, polysilicon, silicon nitride or glass such as PYREX® 7740.

As shown in FIG. 14, the bottom layer 102 is removed, such as by a wet etch (i.e., buffered solution of hydrochloric acid). Alternately, instead of starting with the silicon-on-insulator wafer of FIG. 13 and removing the bottom layer 102, the wafer shown in FIG. 14 may be created using additive techniques. Next, as shown in FIG. 15, the upper layer 108 is patterned to form the upper outer edges of the mass 52, the arms 61, as well as any other desired arms, contacts, protrusions, latches, barbs, etc. to be formed in the upper layer 108. If the sensor 10, 50 includes an actuator, the actuator may also be etched in the upper layer 108 at this time. The etching of the upper layer 108 may be accomplished by a variety of etching methods such as deep reactive ion etching (“DRIE”).

Next, as shown in FIG. 16, the bottom surface of the base layer 104 is etched to form a recess 110 to remove material from what will ultimately be the bottom surface of the mass 52 to enable the mass to move freely relative to the surface or component upon which the sensor is placed (i.e., the surface 39 in FIG. 5). Next, as shown in FIG. 17, The base layer 104 is then etched to define the lower outer edges of the mass 52 and the frame 54. A pair of thin dicing lines 114, 116 (i.e., about 2 microns wide) are also preferably patterned into the base layer 104. The dicing lines 114, 116 make it easier to cut through the wafer 100 during dicing, and increase the ease of handling and packaging the sensor. If it is desired to form any other components in the base layer 104 (i.e., all or part of the contacts 51, 53, 56, 58, arms 61, actuator 60, and other latches, protrusions, barbs, etc.), those components may be etched in the base layer 104 at this time. The base layer 104 may be etched by a variety of methods, such as DRIE.

A photoresist 112 or other protective material, such as polyimid, is then deposited on the upper layer 108 to coat and protect the fragile components of the sensor (i.e., the arms, contacts, latches, etc.) and to couple the mass 52 to the frame 54 (see FIG. 17A). Next, as shown in FIG. 18, the exposed portions of the intermediate layer 106 are removed, such as by wet or dry etching, to release the mass 52 from the frame 54. However, the photoresist 112 is not removed during this step and continues to couple the mass 52 to the frame 54.

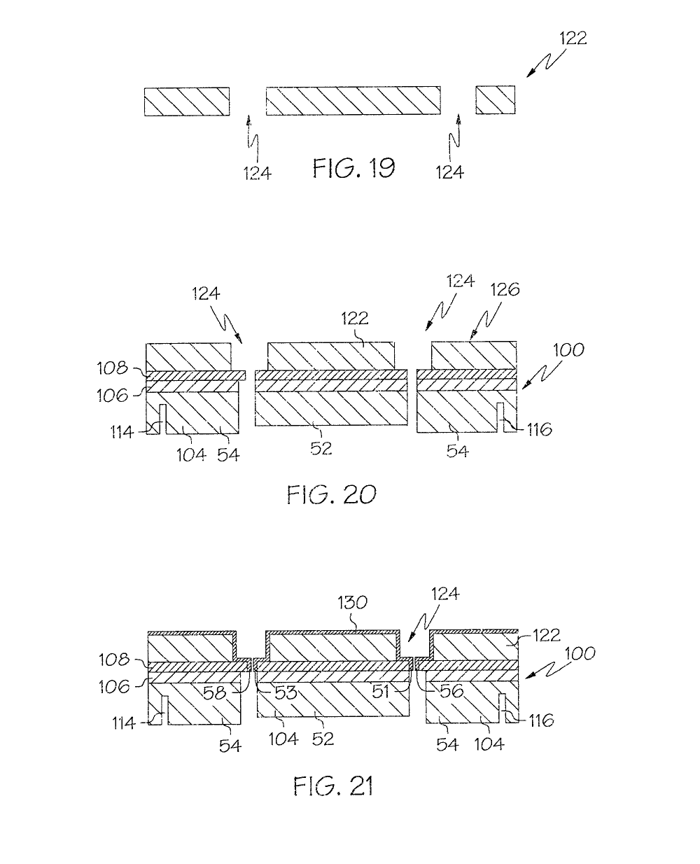

Next, as shown in FIG. 19, a shadow mask 122 having a pair of openings 124 is etched or provided, preferably by providing a 200 micron thick wafer and DRIE etching the wafer to form the mask as shown in FIG. 19. Other standard masks may be used, but the etched silicon wafer mask 122 of FIG. 19 provides good flatness and enables alignment marks to be accurately deposited on the wafer mask 122 by photolithography.

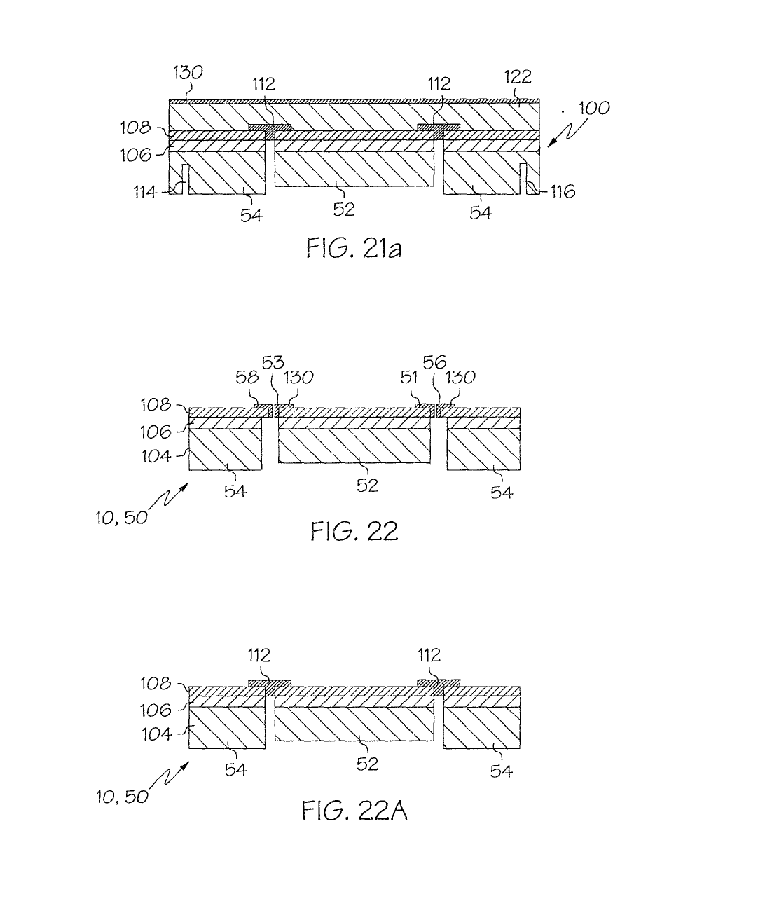

Next, as shown in FIG. 20, the shadow mask wafer 122 is located on the upper layer 108 of wafer 100. A conductive material 130, such as gold with a chromium adhesion layer, is then sputtered onto the shadow mask wafer 122 and onto the wafer 100 and through the openings 124 onto the upper layer 108, as shown in FIG. 21, to form the contacts 51, 53, 56, 58. As shown in FIGS. 21 and 21A, the shadow mask 122 prevents the conductive material 130 from being deposited where the material 130 is not desired. Next, as shown in FIGS. 22 and 22A, the shadow mask 122 is removed, and the sensor is separated from the wafer 100 by scribing, or snapping, the wafer at the dicing lines 114, 116. The sensor can then be packaged between a top cap 41 and a lower wafer 39 as shown in FIG. 5

The sensor 10, 50 may be manufactured such that it is in a rest position at the completion of the manufacturing steps, for example, the sensor 10, 50 may be manufactured such that it is in its position shown in FIG. 1 or 6. The sensor 10, 50 can then be shipped to the end user. When the user is ready to use the sensor, the sensor can be oxygen ashed to remove the protective layer 112 if the protective layer 112 is a photoresist (or, if other materials besides photoresist are used, the other materials are removed by the appropriate method) to release the mass and actuator. The sensor 10, 50 is them mounted onto a component which is desired to be monitored by the sensor, and the sensor is moved to its ready position. Alternately, the protective layer 112 may be omitted or removed prior to packaging of the sensor.

Having described the invention in detail and by reference to the preferred embodiments, it will be apparent that modifications and variations thereof are possible without departing from the scope of the invention.

What is claimed is:

1. A crash sensor comprising:
a frame;
a first contact coupled to said frame;
a second contact coupled to said frame; and
a mass coupled to said frame, said mass being movable relative to said frame between a first position wherein said mass contacts said first contact and not said second contact and a second position wherein said mass contacts said second contact and not said first contact, wherein said mass can be moved from said first position to said second position when said mass experiences a predetermined acceleration force.

2. The crash sensor of claim 1 wherein said first contact includes at least one retaining barb, and wherein said mass includes at least one retaining clip that is shaped to interact with said retaining barb to maintain said mass in said first position.

3. The crash sensor of claim 2 wherein said retaining barb and said retaining clip each include cooperating barb portions.

4. The crash sensor of claim 1 further comprising an actuator shaped to bias said first contact into engagement with said mass when said actuator is in an activated position and said mass is located in said first position.

5. The crash sensor of claim 4 wherein said actuator is coupled to said frame.

6. The crash sensor of claim 4 wherein said actuator includes a pair of actuator beams that are configured to move in a predetermined direction when a current is passed through said actuator beams to cause said actuator to move to said activated position.

7. The crash sensor of claim 6 wherein each beam includes a pair of beam portions, each beam portion in said beams having a differing coefficient of thermal expansion.

8. The crash sensor of claim 4 further comprising a spring element located between said actuator and said frame.

9. The crash sensor of claim 1 wherein said first contact can be biased into engagement with said mass when said mass is in said first position.

10. The crash sensor of claim 9 wherein said first contact is mounted on an actuator, said actuator being coupled to said frame and movable between an activated position wherein said first contact is biased into engagement with said mass, and an unactivated position wherein said first contact is not biased into engagement with said mass.

11. The crash sensor of claim 10 wherein said actuator includes a set of barbs and said frame includes a set of barbs, and wherein said actuator set of barbs and said frame set of barbs can cooperate to maintain said actuator in said activated position.

12. The crash sensor of claim 11 wherein said actuator set of barbs are located on one side of said frame set of barbs when said actuator is in said unactivated position, and wherein said actuator set of barbs are located on opposite sides of said frame set of barbs when said actuator is in said activated position, and wherein said frame barbs and actuator barbs are shaped to allow said actuator to move from said unactivated position to said activated position and to resist movement of said actuator from said activated position to said unactivated position.

13. The crash sensor of claim 12 where said actuator includes a pair of opposed feet coupled to said actuator barb, and wherein said actuator includes a pair of movable actuator beams that can engage said feet and move said actuator to said activated position.

14. The crash sensor of claim 1 wherein said mass includes a first internal contact that can contact said first contact when said mass is in said first position and a second internal contact that can contact said second contact when said mass is in said second position.

15. The crash sensor of claim 14 wherein said first and second internal contacts are located on opposite sides of said mass.

16. The crash sensor of claim 1 further comprising a plurality of flexible arms coupling said frame to said mass.

17. The crash sensor of claim 1 wherein said mass and said frame are silicon.

18. The crash sensor of claim 1 wherein at least part of said mass and at least part of said first and second contacts are made of conductive materials such that said first contact and said mass are electrically coupled when said mass is in said first position and said second contact and said mass are electrically coupled when said mass is in said second position.

19. The crash sensor of claim 1 wherein said mass is shaped to be able to be maintained in said first position in the absence of said predetermined acceleration force.

20. The crash sensor of claim 1 wherein said first and second contacts are located on opposite sides of said frame.

21. The crash sensor of claim 1 wherein said sensor is a microsensor.

22. The crash sensor of claim 1 further comprising a third and a fourth contact coupled to said frame, and wherein said mass electrically couples said first and said third contacts when said mass is in said first position, and wherein said mass electrically couples said second and said fourth contacts when said mass is in said second position.

23. The crash sensor of claim 22 wherein said mass includes a first, second, third and fourth contact, and wherein at least two contacts of said mass each contact a corresponding contact of said frame when said mass is in said first position, and wherein at least the two other of said contacts of said mass each contact a corresponding contact of said frame when said mass is in said second position.

24. The crash sensor of claim 1 wherein said mass and said first contact include interlocking portions such that said interlocking portions can interlock to maintain said mass in said first position in the absence of acceleration forces of a predetermined level.

25. The crash sensor of claim 1 further comprising a control circuit for sensing when said mass is in said second position, and for sending an output signal when said control circuit sensing that said mass is in said second position.

26. A crash sensor comprising:
a frame;
a first pair of contacts coupled to said frame;
a second pair of contact coupled to said frame; and
a mass coupled to said frame, said mass being movable between a first position wherein said mass electrically couples said first pair of contacts and not said second pair of contacts and a second position wherein said mass electrically couples said second pair of contacts said not said first pair of contacts, said mass and said frame being shaped to be able to cooperate to maintain said mass in said first position in the absence of external acceleration forces of a predetermined level, said mass being movable from said first position to said second position when said mass experiences a predetermined acceleration.

27. The crash sensor of claim 26 wherein said mass, in the absence of outside forces, returns to said first position after experiencing said predetermined acceleration.

28. A crash sensor comprising:
a frame;
a first contact coupled to said frame;
a second contact coupled to said frame;
a mass movably coupled to said frame, said mass including a first internal contact and a second internal contact located on opposite sides of said mass, said mass being movable relative to said frame between a first position wherein said first internal contact contacts said first contact of said frame and said second internal contact does not contact said second contact of said frame and a second position wherein said second internal contact contacts said second contact of said frame and said first internal contact does not contact said first contact of said frame, wherein said mass can be moved from said first position to said second position when said mass experiences a predetermined acceleration force; and
an actuator coupled to said frame and being shaped to bias said first contact of said frame into engagement with said first internal contact when said actuator is in an activated position and said mass is located in said first position.

29. A method for using a crash sensor comprising the steps of:
providing a crash sensor including a frame, a first contact, a second contact, and a mass coupled to said frame, said mass being movable between a first position wherein said mass contacts said first contact and not said second contact and a second position wherein said mass contacts said second contact and not said first contact, said mass being movable to said second position when said mass experiences a predetermined acceleration;
moving said mass or said first contact such that said mass is located in said first position; and
mounting said crash sensor on a component.

30. The method of claim 29 wherein said mass and said first contact include interlocking portions, and wherein said moving step includes moving said mass or said first contact such that said interlocking portions interlock to maintain said mass in said first position in the absence of acceleration forces of a predetermined level.

31. The method of claim 29 wherein said first contact is located on an actuator, and wherein said moving step including activating said actuator such that said first contact is biased against said mass.

32. A method for manufacturing a crash sensor comprising the steps of:
providing a wafer of material;
etching said wafer to define a frame and a mass movably coupled to said frame, said mass being movable between a first position and a second position; and
depositing a conductive material on said frame and mass to form a set of contacts on said mass and said frame, wherein at least one contact on said mass contacts at least one contact on said frame when said mass is in said first position, and wherein at least one contact on said mass contacts at least one contact on said frame when said mass is in said second position.

33. The method of claim 32 wherein said wafer includes a base layer, an intermediate layer on said base layer and an upper layer of material on said intermediate layer, and wherein etching step includes etching said upper layer of material to define said frame and said mass, etching said base layer to define said frame and said mass, and removing any of said intermediate layer located between said frame and said mass to release said mass.

34. The method of claim 33 wherein said etching step includes etching an underside of said wafer to reduce the thickness of said mass relative to said frame.

35. The method of claim 34 further comprising the step of locating a protective layer on said wafer after said etching step to temporarily couple said mass to said frame.

36. The method of claim 35 wherein said protective layer is photoresist.

37. The method of claim 36 wherein said depositing step includes placing a mask on said wafer, sputtering a metal onto the exposed portions of said wafer, and removing said mask.

38. The method of claim 37 wherein said mask is made of silicon.

39. The method of claim 33 wherein said base layer and said upper layer are silicon and said intermediate layer is an oxide.

40. The method of claim 32 further comprising the step of etching dicing lines through a predetermined thickness of said wafer, and separating said sensor from said wafer along said dicing lines.

41. The method of claim 32 wherein said etching and depositing steps include forming said mass, said frame and said contacts such that said mass includes a first contact that contacts a first contact of said frame only when said mass is in said first position, and said mass includes a second contact that contacts a second contact of said frame only when said mass is in said second position.

42. The method of claim 32 wherein said etching step includes forming interlocking portions on said mass and said frame, wherein said interlocking portions can cooperate to maintain said mass in said first position.

43. The method of claim 42 wherein said interlocking portions include cooperating barb portions.

44. The method of claim 42 wherein said depositing step includes depositing conductive material on said interlocking portions.

45. The method of claim 32 wherein said etching step includes forming an actuator coupled to said frame, said actuator including at least one contact formed thereon, said actuator being shaped to be able to spring bias said first contact into engagement with said mass when said actuator is moved to an activated position.

46. The method of claim 32 wherein said etching step includes deep reactive ion etching said wafer.
